(19) United States
(12) Patent Application Publication
(10) Pub. No.: US 2015/0221957 A1
(43) Pub. Date: Aug. 6, 2015

(54) METHOD OF MAKING FUEL CELL INTERCONNECT USING POWDER METALLURGY

(71) Applicant: BLOOM ENERGY CORPORATION, Sunnyvale, CA (US)

(72) Inventors: Harald Herchen, Los Altos, CA (US); Chockkalingam Karuppaiah, Cupertino, CA (US); Tad Armstrong, Burlingame, CA (US); Avinash Verma, Cupertino, CA (US)

(21) Appl. No.: 14/687,365

(22) Filed: Apr. 15, 2015

Related U.S. Application Data
(63) Continuation-in-part of application No. 13/679,092, filed on Nov. 16, 2012.
(60) Provisional application No. 61/561,344, filed on Nov. 18, 2011.
(60) Provisional application No. 61/679,201, filed on Aug. 3, 2012.

(51) Int. Cl. H01M 8/02; B22F 5/00; B22F 7/08; B22F 3/02

(52) U.S. Cl. CPC H01M 8/0204; H01M 8/0206; H01M 8/0215; H01M 8/0228; B22F 3/02; B22F 5/00; B22F 7/08

(57) ABSTRACT

Methods of fabricating an interconnect for a fuel cell stack include providing a powder in a die cavity of a powder press apparatus, where the powder includes at least one of a pre-alloyed powder and a pre-sintered powder, compressing the powder in the die cavity of the powder press apparatus using high velocity compaction to form a pressed powder interconnect, and incorporating the pressed powder interconnect into a fuel cell stack, wherein the pressed powder interconnect is incorporated into the fuel cell stack without first sintering the pressed powder interconnect.

### RELATED APPLICATIONS

This application is a continuation-in-part of U.S. application Ser. No. 13/679,092, filed on Nov. 16, 2012, which claims the benefit of priority to U.S. Provisional Application No. 61/561,344, entitled “Fuel Cell Interconnects and Methods of Fabrication,” filed Nov. 18, 2011, and to U.S. Provisional Application No. 61/679,201, entitled “Powdered Metal Preparation and Compaction for Low Permeability Interconnects,” filed Aug. 3, 2012. This application is related to U.S. application Ser. No. 13/678,709, filed on Nov. 16, 2012, and to U.S. application Ser. No. 13/678,981, filed on Nov. 16, 2012. The entire contents of these applications are incorporated by reference herein.

### BACKGROUND

In a high temperature fuel cell system, such as a solid oxide fuel cell (SOFC) system, an oxidizing flow is passed through the cathode side of the fuel cell while a fuel flow is passed through the anode side of the fuel cell. The oxidizing flow is typically air, while the fuel flow can be a hydrocarbon fuel, such as methane, natural gas, pentane, ethanol, or methanol. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

In order to optimize the operation of SOFCs, the oxidizing and fuel flows should be precisely regulated. Therefore, the flow regulating structures, such as interconnects in the fuel cell system should be precisely manufactured. Furthermore, the interconnects of the fuel cell system should be manufactured to have a coefficient of thermal expansion (CTE) that matches the CTE of other components in the stack, such as the SOFC electrolyte.

### SUMMARY

Embodiments include methods of fabricating an interconnect for a fuel cell stack that include providing a powder in a die cavity of a powder press apparatus, where the powder includes at least one of a pre-alloyed powder and a pre-sintered powder, compressing the powder in the die cavity of the powder press apparatus using high velocity compaction to form a pressed powder interconnect, and incorporating the pressed powder interconnect into a fuel cell stack, wherein the pressed powder interconnect is incorporated into the fuel cell stack without first sintering the pressed powder interconnect.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 illustrates a side cross-sectional view of a SOFC stack.

FIGS. 2A and 2B are respective side cross sectional and top views of a powder metallurgy (PM) apparatus for making interconnects for a fuel cell stack.

FIGS. 3A and 3B are respective side cross sectional and top views of a prior art PM apparatus.

### DETAILED DESCRIPTION

The various embodiments will be described in detail with reference to the accompanying drawing. Wherever possible, the same reference numbers will be used throughout the drawing to refer to the same or like parts. References made to particular examples and implementations are for illustrative purposes, and are not intended to limit the scope of the invention or the claims.

Various embodiments include interconnects for a fuel cell stack, and methods of manufacturing such interconnects by metal powder pressing using a single press, near net shape process.

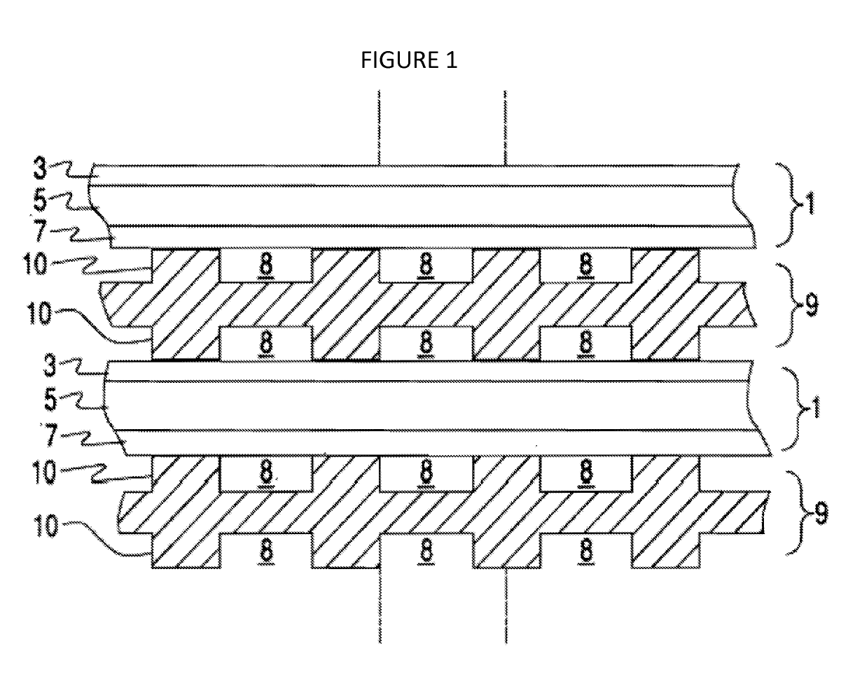

An example of a solid oxide fuel cell (SOFC) stack is illustrated in FIG. 1. Each SOFC 1 comprises a cathode electrode 7, a solid oxide electrolyte 5, and an anode electrode 3. Fuel cell stacks are frequently built from a multiplicity of SOFC's 1 in the form of planar elements, tubes, or other geometries. Fuel and air has to be provided to the electrochemically active surface, which can be large.

The gas flow separator 9 (referred to as a gas flow separator plate when part of a planar stack), containing gas flow passages or channels 8 between ribs 10, separates the individual cells in the stack. Frequently, the gas flow separator plate 9 is also used as an interconnect which electrically connects the anode or fuel electrode 3 of one cell to the cathode or air electrode 7 of the adjacent cell. In this case, the gas flow separator plate which functions as an interconnect is made of or contains electrically conductive material. The interconnect/gas flow separator 9 separates fuel, such as a hydrocarbon fuel, flowing to the fuel electrode (i.e. anode 3) of one cell in the stack from oxidant, such as air, flowing to the air electrode (i.e. cathode 7) of an adjacent cell in the stack. At either end of the stack, there may be an air end plate or fuel end plate (not shown) for providing air or fuel, respectively, to the end electrode. An “interconnect” as used herein refers to both a interconnect/gas flow separator between two adjacent fuel cells in a fuel cell stack as well as to an “end plate” located at an end of a fuel cell stack, unless otherwise specified. FIG. 1 shows that the lower SOFC 1 is located between two interconnects 9.

For solid oxide fuel cell stacks, the interconnect 9 is typically made from an electrically conductive metal material, and may comprise a chromium alloy, such as a Cr—Fe alloy made by a powder metallurgy technique. The powder metallurgy technique may include pressing and sintering a Cr—Fe powder, which may be a mixture of Cr and Fe powders and/or pre-alloyed Cr—Fe powder, to form a Cr—Fe alloy interconnect in a desired size and shape (e.g., a “net shape” or “near net shape” process). A typical chromium-alloy interconnect may comprise at least about 80% chromium, and preferably more than about 90% chromium, such as about 94-96% (e.g., 95%) chromium by weight. The interconnect may contain less than about 20% iron, and preferably less than about 10% iron, such as about 4-6% (e.g., 5%) iron by weight. The interconnect may contain less than about 2%, such as about zero to 1% of other materials, such as yttrium or yttria, as well as residual or unavoidable impurities.

In a conventional method for fabricating interconnects, blended Cr and Fe elemental powders are pressed in a hydraulic or mechanical press to produce a part having the desired interconnect shape. The Cr and Fe powders are blended with an organic binder and pressed into so-called “green parts” using a conventional powder metallurgy technique. The “green parts” have substantially the same size and shape as the finished interconnect (i.e., “near net shape”). The organic binder in the green parts is removed before the parts are sintered. The organic binder is removed in a debinding process in a furnace that is operated at atmospheric pressure at a temperature of 400° C. to 800° C. under flow of hydrogen gas. After debinding, the compressed powder Cr—Fe interconnects are sintered at high-temperature (e.g., 900-1550° C.) to promote interdiffusion of the Cr and Fe. The interconnects may undergo a separate controlled oxidation treatment, such as by exposing the interconnects to an oxidizing ambient, such as air at high temperature after sintering, prior to use of the interconnects in the stack.

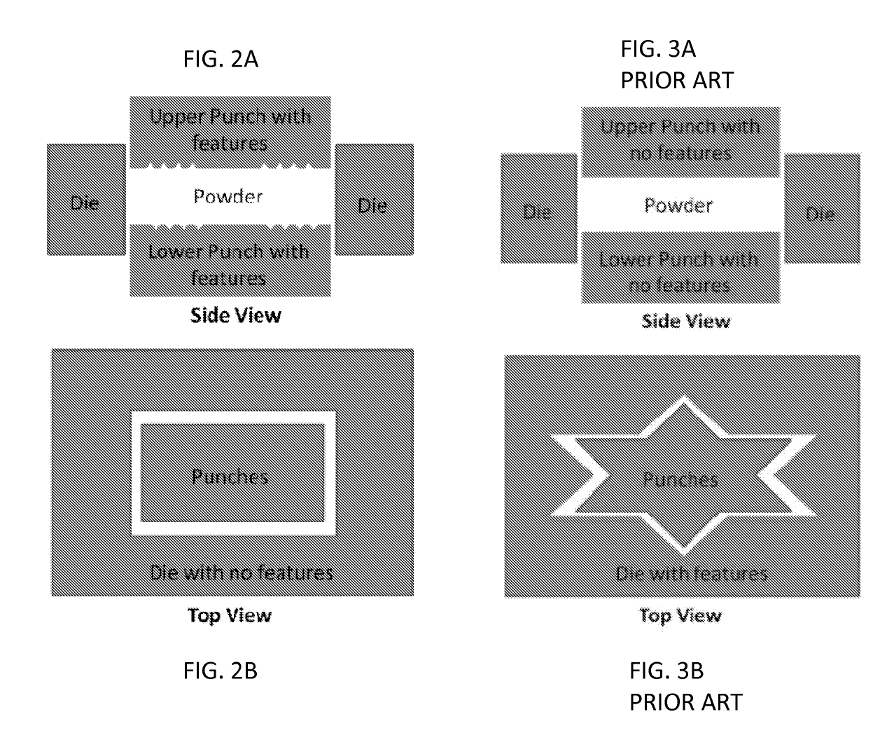

Powder metallurgy (PM) technology creates the shape of a part using three components in a compaction press—the upper punch, the lower punch and a die. The design of the interconnect necessitates various cross sectional thickness to be molded by features on the punches, i.e., there is cross sectional thickness variation in the direction of compaction tonnage (FIGS. 2A and 2B). This is different from most parts that are processed using PM technology where the punches are typically flat and the die is the component that contains the geometric features, i.e., the cross sectional thickness in the direction of compaction tonnage is uniform (FIGS. 3A and 3B).

In embodiments, a method for fabricating an interconnect for a fuel cell stack comprises forming the interconnect via a single-press technique using high-velocity compaction. A single press method may include pressing the metal powder at extremely high speeds, including explosive or near-explosive speeds. The powder may be a clean unoxidized surface with no lubricant in it. The powder can be, for example, a chromium powder and iron powder mixture, a pre-sintered Cr—Fe powder, optionally mixed with Cr particles, and/or a pre-alloyed Cr—Fe powder, optionally mixed with Cr particles. Using a high-speed single press process, an interconnect can be formed in less than 3 seconds, such as less than 1 second, and typically less than 0.5 seconds (e.g., 0.2 seconds or less). In embodiments, the duration of compaction of the interconnect (i.e., from start to stop of compressing the powder that has been loaded into a die cavity) may be between about 2-200 milliseconds. In certain embodiments, an interconnect formed via a high-speed single-press process may require no sintering and/or oxidation due the high-speed of the press and high-density of the pressed powders. Alternatively, if desired, the interconnect may be subjected to one or more post-compaction processes before being incorporated into a fuel cell stack, such as a de-lubing process, a sintering process, and/or an controlled oxidation process. A combustion-driven powder compaction apparatus which can be used in a high-speed, single press powder press process is commercially available from UTRON Kinetics, LLC of Manassas, Va. Alternatively, a high velocity compaction apparatus may use the impact of a hydraulically accelerated cylinder to compact the powder.

In various embodiments, the high speed, single press powder compression (compaction) method can take place in two stages. A first compaction stage can take about one to two seconds to achieve at least 40%, such as 40-60% (e.g., ˜50%) of the total compaction, and then the second stage can take 0.1 to 100 milliseconds, and typically about 10 milliseconds, for the remaining at least 40%, such as 40-60% (e.g., ˜50%) of the compaction. The first stage may be performed with a gas fill of the cylinder of the pressing apparatus to push the powder down to about 50% or greater of the final compaction state. The remaining compaction, which is typically about 50% or less of the total compaction, can be driven by a rapid combustion (explosion) of the gas fill of the cylinder of the pressing apparatus to raise the compaction force higher, and allow shock waves to break the powder into smaller pieces and fill the pores. Alternatively, the pressing apparatus may be driven at high speed via hydraulic acceleration. This is known in the field as “high velocity compaction.” A conventional compaction apparatus may reach a compacting speed at impact of between about 0.02 msec. and 0.1 msec. High velocity compaction is characterized by compacting speeds at impact that are greater than 0.1 msec, such as greater than about 1.0 msec, and may be in a range between about 1.0 msec and 100 msec. Generally, a high velocity compaction process is sufficient to provide a single-press, net shape or near net shape interconnect according to various embodiments. In embodiments, the high velocity compaction may provide at least about 40% of the total compaction of the interconnect in 100 msec or less (e.g., 50 msec). It will be understood that certain high velocity compaction methods, such as explosive compaction, may reach a compacting speed sufficient to cause the particle interfaces melt due to frictional heating, and could be used in various embodiments, as discussed further below.

In various embodiments, an interconnect formed using high-velocity compaction as described above can have a relatively high density, and therefore low gas permeability, which may eliminate the need to subject the interconnect to an oxidation treatment prior to installation of the interconnect into a fuel cell stack. The interconnect formed by high-velocity compaction can have very low gas permeability to prevent hydrogen and other gases from penetrating the interconnect.

Further embodiment methods of fabricating an interconnect using high-velocity compaction include providing a pre-sintered chromium/iron powder mixture, and compressing (compacting) the pre-sintered powder mixture using a high-velocity compaction apparatus to form the interconnect. As used herein, “pre-sintered” means that the combined or agglomerated particles (e.g., Cr—Fe particles) are subjected to a treatment at elevated temperature in a reducing ambient to produce at least some interdiffusion of the constituent materials, although the materials need not be perfectly mixed at the atomic level, such as in alloyed materials. By using pre-sintered powders, sintering the compacted interconnect for diffusion purposes may not be needed. In some embodiments, such as when the metal powder stock is sufficiently “clean” (i.e., free of oxides), the high-velocity compaction can make the interconnect strong enough so that no sintering at all is needed. Thus, in these methods, the interconnect is not sintered (i.e., not subjected to a temperature required for sintering) between the steps of pressing and being provided into a fuel cell stack (and preferably between the steps of pressing and operating the fuel cell stack to generate electricity). If desired, a pre-sintering step can be added before the pressing step or the pre-sintering step can also be omitted, such that the interconnect is not sintered between the steps of providing the starting powder for the eventual pressing step and providing the interconnect into a fuel cell stack.

Further embodiment methods of fabricating an interconnect using high-velocity compaction include providing a chromium/iron powder mixture and a coating material over at least one surface of the chromium/iron powder mixture, and compressing (compacting) the chromium/iron powder mixture and the coating material using a high-velocity compaction process to form an interconnect having a coating over at least one surface. The coating material can be a powder. It is known to provide a coating to a surface of an interconnect, such as on the air (cathode) side of the interconnect, in order to decrease the growth rate of a chromium oxide surface layer on the interconnect and to suppress evaporation of chromium vapor species which can poison the fuel cell cathode. Typically, the coating layer, which can comprise a perovskite such as lanthanum strontium manganite (LSM), is formed using a spray coating or dip coating process. Alternatively, other metal oxide coatings, such as a spinel, such as an (Mn, Co)₃O₄ spinel, can be used instead of or in addition to LSM. Any spinel having the composition Mn₂₋ₓCo₁₊ₓO₄ (0≦x≦1) or written as z(Mn₃O₄)+(1−z)(Co₃O₄), where (⅓≦z≦⅔) or written as (Mn, Co)₃O₄ may be used. In various embodiments, the coating material (e.g., LSM or another metal oxide coating material, or a spinel, such as an (Mn, Co)₃O₄ spinel) can be provided in powder form in the die cavity with the chromium/iron powder, and is preferably provided in the area of the die cavity corresponding to the air (cathode) side surface of the interconnect (e.g., above or below the chromium/iron powder in the die cavity). The powder is then compressed (compacted), preferably at high-velocity, to form an interconnect having a coating layer over the air (cathode) side surface of the interconnect. This can allow elimination of the LSM coating process for the air side, cutting the cost substantially. It can also be used to provide much higher density coatings, which can further reduce leakage of chromium through the coating.

Further embodiments include methods of fabricating an interconnect using a high-velocity compaction method, such as a hydraulic-driven or combustion-driven compaction method (e.g., explosive compaction) to provide a high-density pressed metal powder interconnect. In various embodiments, the metal powder used for compacting may include pre-sintered powders (e.g., pre-sintered Cr—Fe powders), power mixtures, and/or pre-alloyed powders (e.g., Cr—Fe alloy powder), and the metal powder stock may have an overall average CTE that substantially matches the CTE of a component of a fuel cell, such as the fuel cell electrolyte. The compacting may be performed in sub-atmosphere (i.e., less than 1 atmosphere) environment, including in a vacuum environment. An interconnect produced from the compacted metal powder according to the embodiment method may have a good CTE match to the fuel cell electrolyte, may have low permeability and high resistance to oxidation. In various embodiments, the pressed metal powder interconnect may be incorporated into a fuel cell stack without performing a separate sintering step and/or oxidation step after the compacting.

The method for fabricating an interconnect may utilize a powder metallurgy technique using a compaction method that enhances higher densities, such as high tonnage (e.g., more than 1000 ton hydraulic presses). Alternatively or in addition, various embodiments may use a combustion driven compaction process, where the compaction force is applied over less than 1 second, such as less than 100 msec, (e.g., 50 msec or less, such as 10-40 msec). The compaction of the metal powder is preferably performed under vacuum or sub-atmosphere pressure (e.g., below 1 atm, or 760 Torr, pressure). In embodiments, the compaction may be performed in a pressure of approximately 1×10⁻³ Torr or less (e.g., 10⁻³ to 10⁻⁶ Torr). In various embodiments, the compaction may be performed in a sub-atmospheric pressure between 1×10⁻³ Torr and 750 Torr, such as 1×10⁻³ to 25 Torr, 25-100 Torr, 100-250 Torr, 250-500 Torr, or 500-750 Torr. In some embodiments, no or substantially no lubricant material (e.g., organic lubricant) or organic binder is present in the powder metal stock during the compaction.

The metal powder stock for the compaction may be or may include a pre-sintered powder that includes pre-sintered, agglomerated particles containing two or more metals. In preferred embodiments, the pre-sintered powder contains chromium and iron. In various embodiments, the metal powder stock is a mixture of pre-sintered powder(s) containing two or more metals (e.g., Cr/Fe) and other powder(s) that may consist of a single metal, such as pure chromium powder. In one embodiment, pre-sintered particles of Fe/Cr can be made by binding Fe particles to the surface of Cr particles, and then sintering those agglomerated particles. The sintering redistributes the Cr into the Fe, making a substantially oxide free particle that is mostly Cr, but may also include a relatively high Fe content (e.g., >6%, such as greater 7%, such as between about 10% and about 35% Fe by weight). The larger Fe content allows compaction to occur with less pressure, since Fe is more compressible than Cr. Optionally, all or a portion of the powder stock may be obtained by crushing previously-fabricated (i.e., recycled) interconnects.

A pressed powder metal interconnect should have a generally uniform CTE (both within each interconnect and over multiple interconnects within a stack), where the CTE has an acceptable match with the CTE of neighboring components of the fuel cell stack (e.g., the fuel cell electrolyte material), and the interconnect should also have low permeability. In the prior art, this is achieved by compacting the powder and then sintering and oxidizing the resulting parts. Using a metal powder stock of pre-sintered powder, the interconnect CTE may be matched from the start (i.e., without requiring a separate sintering step of the pressed part) to the CTE of the neighboring component of the fuel cell stack (e.g., fuel cell electrolyte). Thus, an appropriate mixture of pre-sintered Cr/Fe particles with pure Cr particles can be compacted to obtain the desired interconnect CTE. This powder mixture may consist of pre-sintered particles that are between 4-35% Fe and 65-96% Cr (e.g., 25% Fe and 75% Cr) by weight. These pre-sintered particles may be mixed with Cr particles before compaction, with a ratio chosen to obtain the desired overall average interconnect CTE across the part, without long sintering. Preferably, the compacted interconnect made from a mixture of pre-sintered Cr/Fe particles and pure Cr particles contains 4-6% wt. of Fe and the balance Cr and unavoidable impurities.

In embodiments, the average CTE of the metal powder, prior to compacting, may match the CTE of a component of a fuel cell, and in particular the CTE of an electrolyte material of an electrolyte-supported fuel cell. In various embodiments, the average CTE of the powder may be within about 10%, such as within 5% of the CTE of an electrolyte material for the fuel cell, including within about 1% of the CTE of the fuel cell electrolyte. The fuel cell may be a solid oxide fuel cell having a ceramic electrolyte material, which may be a stabilized zirconia, such as scandia stabilized ziconia (SSZ) and/or yttria stabilized zirconia (YSZ).

Alternatively, the electrolyte may comprise another ionically conductive material, such as a doped ceria. In some embodiments, the CTE of the compacted powder may be between about 7×10⁻⁶/° C. and 13×10⁻⁶/° C., such as 8.5-10.5×10⁻⁶/° C., including 9-10×10⁻⁶/° C. (e.g., 9.53-9.71×10⁻⁶/° C., such as 9.57-9.67×10⁻⁶/° C.), and preferably about 9.62×10⁻⁶/° C., to match the 9.62×10⁻⁶/° C. CTE of SSZ. Alternatively, the CTE of the compacted powder can be between about 9.5-11.5×10⁻⁶/° C., such as 10-11×10⁻⁶/° C. (e.g., 10.4-10.6×10⁻⁶/° C.), and preferably about 10.5×10⁻⁶/° C., to match the 10.5×10⁻⁶/° C. CTE of YSZ. For anode supported cells, the CTE of the compacted powder may be selected to match the anode CTE.

The sintered powder is preferably relatively oxide free, and in order to maintain it oxide free, the powder may be kept under vacuum. In addition, the powder may be maintained in a sub-atmospheric pressure environment and/or a reducing atmosphere environment when the powder is delivered to and loaded within the compacting device (e.g., loaded into the shoe/die cavity of the press). This environment may ensure that little trapped air is present in the compacted part and may also be useful to prevent the powder from oxidizing.

The rapid compaction of the powder (e.g., less than 2 seconds, e.g., less than 100 msec, such 50 msec or less duration) ensures that the surfaces at which the friction occurs between the particles have a lot of heat generation. This may ensure bonding of the material during compaction, so sintering may not be needed. The rapid compaction also helps increase density, preferably to the point of impermeability, so the oxidation step normally used may also be eliminated.

In embodiments, the interconnect may be formed using explosive compaction, which is a combustion-driven compaction technique that operates at sufficiently high velocities to cause the particle interfaces to melt due to frictional heating. Explosive compaction processes are available from High Energy Metals, Inc. of Sequim, Wash.

Compacting interconnects rapidly (e.g., in milliseconds) has the advantage of achieving higher densities for the same peak compaction force. The reason is that the frictionally driven energy deposition occurs more quickly, and does not penetrate into each powder particle as far before compaction motion stops. A potential issue with this approach is that air trapped in the powder gets compressed to very high pressures, possibly enough to make the parts explode.

Compacting the powder in a sub-atmospheric or vacuum environment has the advantage of avoiding the excessive compression of the trapped air, since there is much less air. It has the additional advantage of avoiding oxide formation at the locally created high temperatures, so the metal particles stick together better. This may be sufficient to enable the pressed powder interconnect to be used in a fuel cell stack under operating conditions without sintering the interconnect prior to use. In embodiments, the powder may be compacted without any lubricant or organic binder being present in the powder and/or in the environment of the die cavity. By omitting the lubricant from the metal powder and/or the die cavity, the volume that needs to be closed to achieve low permeability is much smaller than with the lubricant or binder being present. This results in a less expensive, low permeability part with no additional processing. The absence of the lubricant may also facilitate the pumping down of the processing chamber to provide the desired sub-atmosphere or vacuum environment in embodiments in which the compaction is performed in a sub-atmosphere or vacuum environment. In embodiments, agglomerating the Fe particles onto the Cr particles, and then pre-sintering the combined Cr—Fe particles in hydrogen to distribute the Cr into the Fe for use as at least a portion of the powder that is compacted to form the interconnect has the following advantages. The compressibility of Fe is higher than that of Cr, so by choosing to use particles with more than the approximately 6 wt % Fe in them, the particles are relatively softer, which is beneficial for ease of compaction. In embodiments, the minimum amount of Cr in the particle should ensure that the Fe does not oxidize, so that the subsequent processing steps can be performed without the need for hydrogen reduction. By providing relatively larger and/or softer particles in combination with pure Cr particles, the compaction step may be eased, while maintaining the 4-6% wt. Fe content and overall CTE matching that is desired for the finished interconnect.

In general, pre-sintered fractions of the powder particles may enable eliminating hydrogen from sintering. Vacuum compaction enables particles sticking together so much that sintering is not needed. And explosive compaction other high velocity compaction along with significant Fe fraction in particles enables the elimination of the oxidation step normally used to fill the pores in the interconnect and stop the leaks through the interconnect.

In embodiments, the metal powder stock for the compaction may include a pre-alloyed powder that includes metal alloy particles each containing two or more metals. In preferred embodiments, the pre-alloyed powder contains chromium and iron. The pre-alloyed powder may be formed using any suitable method, such as any method described in U.S. Pat. No. 8,840,833 issued Sep. 23, 2014 and incorporated herein by reference in its entirety. For example, one embodiment method includes a direct reduction technique using chrome ore (FeₓCr_{y}O_{z}). In other embodiments, the pre-alloyed powder may be formed using an aluminothermic process in which iron oxide is added to chromium oxide and the mixture is reduced in a conventional aluminothermic process as is currently used for making Cr metal. In other embodiments, the pre-alloyed powders may be formed using a silicothermic process using chrome ore to obtain the Cr—Fe based alloy. The pre-alloyed material (e.g., Cr—Fe) may be directly formed as a powder, or may be formed as a solid alloy (e.g., ingot) which may be crushed to form pre-alloyed powders having a desired size (e.g., particles having a mean and/or median dimensional size that is between about 110-160 μm). In further embodiments, the pre-alloyed powder may comprise smaller particles (e.g., pre-alloyed particles having a mean and/or median dimensional size that is less than about 30 μm) that are agglomerated using a suitable method (e.g., via spray drying) to provide agglomerated particle clusters having a desired size (e.g., a mean and/or median dimensional size that is between about 110-160 μm).

The pre-alloyed metal powders may optionally be mixed with other metal powders (e.g., elemental Cr and/or Fe powders) to provide a powder mixture that will result in a desired coefficient of thermal expansion (CTE) in the final interconnect. The metal powder stock may include pre-alloyed powder in addition to a “pre-sintered” powder as described above. A pre-sintered powder includes combined or agglomerated particles (e.g., Cr and Fe particles) that are subjected to an elevated temperature in a reducing ambient to produce at least some interdiffusion of the constituent materials, although the materials need not be perfectly mixed at the atomic level, such as may be the case in pre-alloyed materials.

Optionally, in an alternative embodiment, all or a portion of the pre-alloyed and/or pre-sintered powder may be obtained by crushing previously-fabricated (i.e., recycled) interconnects. The crushed recycled interconnects may be annealed at elevated temperature in a reducing (e.g., hydrogen-containing) environment to reduce the oxide content of the powder.

In some embodiments, the pre-alloyed metal powders may be compressed using high velocity compaction without any organic binder (i.e., lubricant) being present in the die cavity.

In some embodiments, the pre-alloyed metal powders may be compressed using high velocity compaction to form a pressed-powder interconnect, and the pressed powder interconnect may be incorporated into a fuel cell stack without performing a separate sintering step. In some embodiments, the pressed powder interconnect may be incorporated into a fuel cell stack without performing a controlled pre-oxidation step.

As described above, a coating material may be provided in powder form over at least one surface of the chromium/iron powder mixture prior to compaction. Compacting the chromium/iron powder mixture and the coating material using a high-density compaction process (e.g., explosive compaction) may produce an interconnect having a coating over at least one surface. The coating may be, for example, a metal oxide coating, such as a perovskite such as lanthanum strontium manganite (LSM), and/or a spinel, such as an (Mn, Co)₃O₄ spinel, etc., which may be provided over the cathode (air) side of the interconnect.

In various embodiments, additional elements may be added to the chromium/iron powder mixture prior to compaction to promote the in situ formation of a protective layer over at least one surface of the interconnect. As described above, it is known to provide a coating, such as perovskite (e.g., LSM) or a metal oxide coating (e.g., a spinel, such as an (Mn, Co)₃O₄ spinel), on a surface of an interconnect, such as on the air (cathode) side of the interconnect, in order to decrease the growth rate of a chromium oxide surface layer on the interconnect and to suppress evaporation of chromium vapor species which can poison the fuel cell cathode. The coating layer may be formed using a spray coating or dip coating process, or by providing the coating material in powder form over at least one surface of the chromium/iron powder mixture prior to compaction, as described above.

In embodiments, one or more additional elements are added to the chromium/iron powder mixture prior to compaction to promote the formation of a protective or barrier layer, which may be a spinel layer. In some embodiments, the protective or barrier layer may be an interfacial layer between the Cr/Fe interconnect body and one or more additional layers overlying the interfacial layer. For example, one or more of Mn, Co, Cu and Ni powders may be added to the chromium/iron powder mixture in a total amount of 1% by weight or less, such as 0.5% by weight or less, and compacted to form an interconnect, preferably by a high-speed single press process. For example, a combination of Cu and Mn powders or Cu, Ni and Mn powders may be added to the Cr and Fe powders. The small amount of Mn, Co, Cu and/or Ni may aid in promoting the in situ formation of a protective barrier layer over at least one surface of the interconnect. The protective barrier layer may include one or more spinels, such as a (Mn, Cr)₃O₄ and/or (Mn, Co, Cr)₃O₄ spinel, which may optionally be doped with Cu and/or Ni to provide a lower resistivity, such as a (Mn, Cu, Cr)₃O₄ spinel or a (Mn, Cu, Ni, Cr)₃O₄ spinel.

FIGS. 2A and 2B are respective side cross sectional and top views schematically illustrating a powder metallurgy (PM) apparatus for making interconnects for a fuel cell stack using high velocity compaction according to various embodiments. A powder may be provided in a die cavity, located between respective upper and lower punches. The upper punch and/or the lower punch may be driven, such as by rapid combustion or hydraulic acceleration, to compact the powder at high velocity (e.g., at a compacting speed at impact of between about 0.02 m/sec and 100 m/sec, such as between 0.1 m/sec and 1.0 m/sec). Features on the upper punch and/or the lower punch may produce a compressed powder interconnect having features with varying cross-sectional thickness, such as the ribs 10 and fluid flow channels 8 shown in FIG. 1, as well as other features, such as riser channel(s) and plenum(s). In embodiments, all or a portion of the PM apparatus may be located in a chamber (e.g., a room) and a vacuum source (not shown) may be coupled to the chamber and operable to provide a sub-atmospheric environment within a portion of the PM apparatus, including the die cavity, so that the compaction may be performed in a sub-atmospheric environment.

While solid oxide fuel cell interconnects, end plates, and electrolytes were described above in various embodiments, embodiments can include any other fuel cell interconnects, such as molten carbonate or PEM fuel cell interconnects, or any other metal alloy or compacted metal powder or ceramic objects not associated with fuel cell systems.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Further, any step of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A method of fabricating an interconnect for a fuel cell stack, comprising:
providing a powder in a die cavity of a powder press apparatus, wherein the powder comprises at least one of a pre-alloyed powder and a pre-sintered powder;
compressing the powder in the die cavity of the powder press apparatus using high velocity compaction to form a pressed powder interconnect; and
incorporating the pressed powder interconnect into a fuel cell stack, wherein the pressed powder interconnect is incorporated into the fuel cell stack without first sintering the pressed powder interconnect.

2. The method of claim 1, wherein the pressed powder interconnect is incorporated in the fuel cell stack without first performing a controlled oxidation of the pressed-powder interconnect.

3. The method of claim 1, wherein the powder comprises a pre-alloyed powder comprising metal alloy particles each containing two or more metals.

4. The method of claim 3, wherein the pre-alloyed powder contains chromium and iron.

5. The method of claim 4, wherein the pre-alloyed powder is formed using at least one of a direct reduction technique using chrome ore (FeₓCr_{y}O_{z}), an aluminothermic process, and a silicothermic process.

6. The method of claim 4, wherein the powder comprises a mixture of a pre-alloyed powder containing chromium and iron and at least one of a pre-sintered chromium-iron powder, an elemental chromium powder and an elemental iron powder.

7. The method of claim 4, wherein the pre-alloyed powder comprises particles having at least one of a mean and a median dimensional size that is between about 110-160 μm.

8. The method of claim 4, wherein the pre-alloyed powder comprises pre-alloyed particles having at least one of a mean and a median dimensional size that is less than about 30 μm that are agglomerated to provide agglomerated particle clusters having at least one of a mean and a median dimensional size that is between about 110-160 μm.

9. The method of claim 4, wherein the powder is provided in the die cavity such that the average CTE of the compressed powder interconnect substantially matches a coefficient of thermal expansion (CTE) of a component of a fuel cell.

10. The method of claim 9, wherein the component of a fuel cell comprises a solid oxide electrolyte material of an electrolyte-supported solid oxide fuel cell.

11. The method of claim 1, wherein the powder is compressed without any organic lubricant being present in the powder.

12. The method of claim 1, wherein at least a portion of the metal powder comprises recycled interconnects that have been crushed.

13. The method of claim 1, wherein providing the powder in the die cavity of the powder press apparatus comprises providing a metal powder comprising at least one of a pre-alloyed powder and a pre-sintered powder and a coating material powder above or below the metal powder in a die cavity, and compressing the powder comprises compressing the metal powder and the coating material powder to form an interconnect having a coating of the coating material on at least one surface of the interconnect.

14. The method of claim 13, wherein the coating material comprises lanthanum strontium manganite (LSM).

15. The method of claim 13, wherein the coating material comprises a spinel.

16. The method of claim 15, wherein the coating material comprises a (Mn, Co)₃O₄ spinel.
